(19) United States
(12) Patent Application Publication
(10) Pub. No.: US 2011/0011777 A1
(43) Pub. Date: Jan. 20, 2011

(54) Apparatus and process for removal of residue from a screen

(76) Inventors: R. Kenneth Trussell, Sandersville, GA (US); Edward C. Harper, Tennille, GA (US); Thomas E. Lovett, Tennille, GA (US)

Correspondence Address: Baker Donelson;Intellectual Property Department, Monarch Plaza, Suite 1600, 3414 Peachtree Rd., ATLANTA, GA, 30326, US

(21) Appl. No.: 12/460,472

(22) Filed: Jul. 20, 2009

(51) Int. Cl. B07B 1/55; B07B 1/46

(52) U.S. Cl. 209/380

(57) ABSTRACT

An apparatus and process are provided for the removal (by washing) of residue from a screen during a screening process.

### TECHNICAL FIELD

This invention relates the removal of residue from a screen. In a more specific aspect, this invention relates to an apparatus and process for removing residue from a screen in a screening process.

This invention will be described in detail with specific references to kaolin clay (or kaolin) as the feed or starting material to be screened. However, this invention will be understood as also applicable to the screening of other starting materials, such as calcium carbonate, bentonite, calcium sulfate (also referred to as gypsum), talc, zeolite, titanium dioxide and other finely distributed materials.

### BACKGROUND OF THE INVENTION

The screening and washing of minerals has long been an important step of minerals processing. Vibratory screens have perhaps been the most used unit in this stage of the process. However, due to the abrasive nature and irregularities in the particle size and shape of most minerals, screen wear and blinding have been problems associated with screening. To minimize screen wear and blinding, operators must monitor and manually wash the screens when necessary. However, manual washing is not economically feasible.

In this application, the term “screen wear” refers to the abrasive action of the material being screened on an opening in the screen, until such action causes the openings to wear away, which leads to a larger opening in the screen. Also, in this application, the term “blinding” refers to the partial or full closure of an opening in the screen by the collection of material which did not pass through the screen, which leads to a less effective screen.

Kaolin is a naturally occurring, relatively fine, white clay mineral which may be generally described as a hydrated aluminum silicate. The ideal structural formula of kaolin can be represented as Al₂Si₂O₅(OH)₄. After purification and beneficiation, kaolin is widely used as a filler and pigment in various materials, such as rubber and resins, and in various coatings, such as paints and coatings for paper.

The use of kaolin in paper coatings serves, for example, to improve brightness, color, gloss, smoothness, opacity, printability and uniformity of appearance of the coated paper. As a filler in paper formulations, kaolin is used to extend fiber and reduce cost, and to improve opacity, brightness and other desirable characteristics of the filled paper product.

Kaolin clay is naturally hydrous and may contain as much as 13.95% water in the structure in the form of hydroxyl groups. Examples of hydrous kaolin clay are the products marketed by Thiele Kaolin Company (Sandersville, Ga.) under the trademarks Kaofine 90 and Kaolux.

Kaolin and other materials are screened for several reasons, such as to reduce residue and to size and/or separate the components of the material being screened. In this application, the term “residue” will be understood to mean sand, mica, gangue materials, dirt, rocks, oversized particles, oversized clay particles and other components which desirably are removed during a screening process.

The screening process provides an improved material which is better suited for various end uses.

Therefore, there is a need in the industry for an apparatus and process for removing residue from a screen to eliminate or minimize the problems which result from the current screening operations.

### SUMMARY OF THE INVENTION

Briefly described, the present invention provides an apparatus and process for removing residue from a screen in a screening process.

The removal of residue by use of the apparatus and process of this invention provides several advantages, including (1) the removal of oversized particles from the material being screened, (2) an increased recovery of the screened product due to eliminating or minimizing blinding and flooding of the screen and (3) reduced screen wear caused when oversized particles are lodged in the screen openings and eventually forced through the screen. Another advantage provided by the apparatus and process of this invention is that finer mesh screens can be used due to reduced screen wear.

### BRIEF DESCRIPTION OF THE DRAWINGS

FIG. 1 shows a plan view of an apparatus according to this invention.

FIG. 2 shows a left side view of the apparatus shown in FIG. 1.

FIG. 3 shows a right side view of the apparatus shown in FIG. 1.

FIG. 4 shows an example of an elongated spray bar with attached nozzles for use in an apparatus according to this invention.

FIG. 5 shows a rear view of an apparatus according to this invention.

### DETAILED DESCRIPTION OF THE INVENTION

The present invention provides an apparatus for removing residue from a screen in a screening process, wherein the apparatus comprises (a) a support frame for the apparatus; (b) an elongated spray bar being connected to a source of cleansing liquid, wherein at least one nozzle is fixedly connected to the elongated spray bar; (c) a pivoting lever arm for rotating the elongated spray bar in clockwise and counterclockwise directions and being fixedly connected to an end of the elongated spray bar; (d) an elongated connecting bar hingedly connected at a point on the lever arm opposite to the end fixedly connected to the elongated spray bar; (e) a mechanism for moving the lever arm in forward and rearward directions; and (f) a valve for controlling a flow of cleansing liquid to each nozzle.

This invention also provides a process for removing residue from a screen in a screening process, wherein the process comprises the steps of (a) placing a product to be screened onto a screen located under and at a distance from an elongated spray bar connected to a source of cleansing liquid, wherein at least one nozzle is fixedly connected to the elongated spray bar, and wherein the elongated spray bar is rotated in clockwise and counterclockwise directions by a pivoting lever arm fixedly connected to an end of the elongated spray bar and hingedly connected at a point on an elongated connecting bar; and (b) providing a flow of cleansing liquid to and through each nozzle fixedly connected to the elongated spray bar and directed toward the screen, wherein the cleansing liquid removes residue from the screen, and wherein the flow of cleansing liquid and rotation of the elongated spray bar are controlled by an external device.

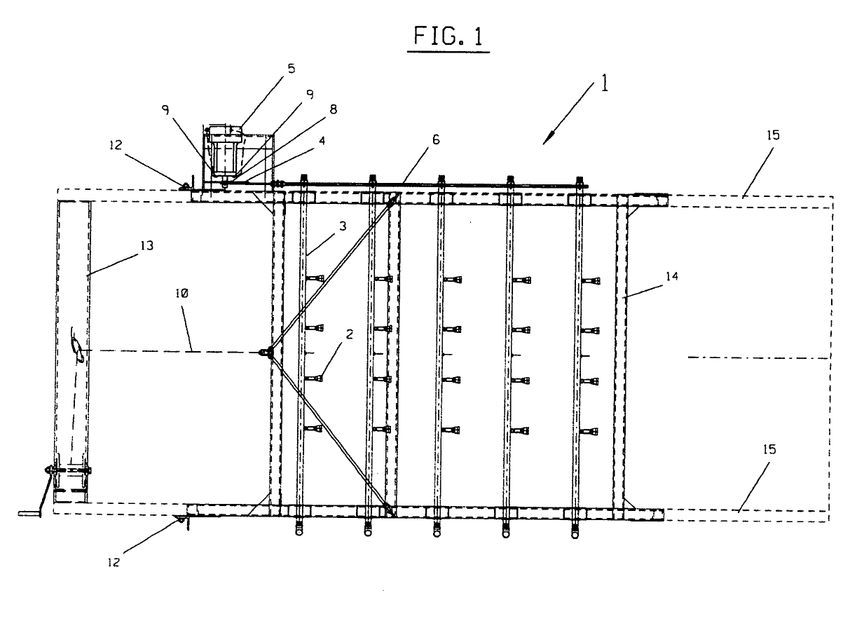

Referring now to the drawings, in which like numbers represent like elements, FIG. 1 shows a preferred embodiment of the apparatus 1 of this invention, in which a support frame 14 for the apparatus is shown with hinges 12. The apparatus includes elongated spray bars 3 having nozzles 2 fixedly connected to each elongated bar 3. A source of cleansing liquid (not shown) is connected to each elongated spray bar 3.

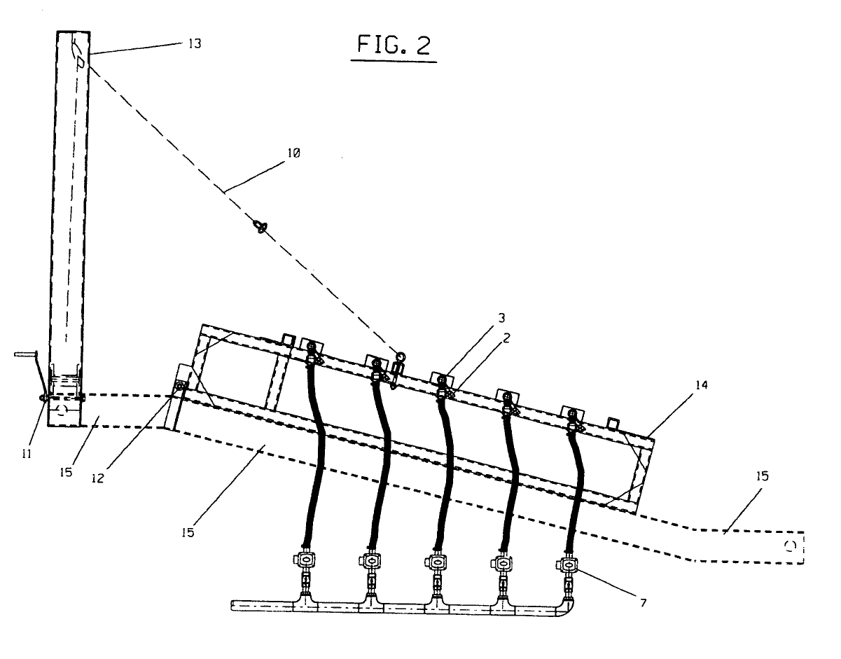

FIG. 2 shows a support frame 14 with hinge 12 (an equivalent hinge 12 on the opposite side not shown) and valve 7 (preferably a solenoid valve) which controls the flow of cleansing liquid to each elongated spray bar 3. A typical screen 15 for a screening process is shown in FIG. 2. Also shown in FIG. 2 is an arrangement of cable 10, winch 11 and an overhead bar assembly 13. This arrangement (or mechanism) may be provided to elevate the apparatus at hinges 12 to facilitate maintenance, replacement of screen panels, etc.

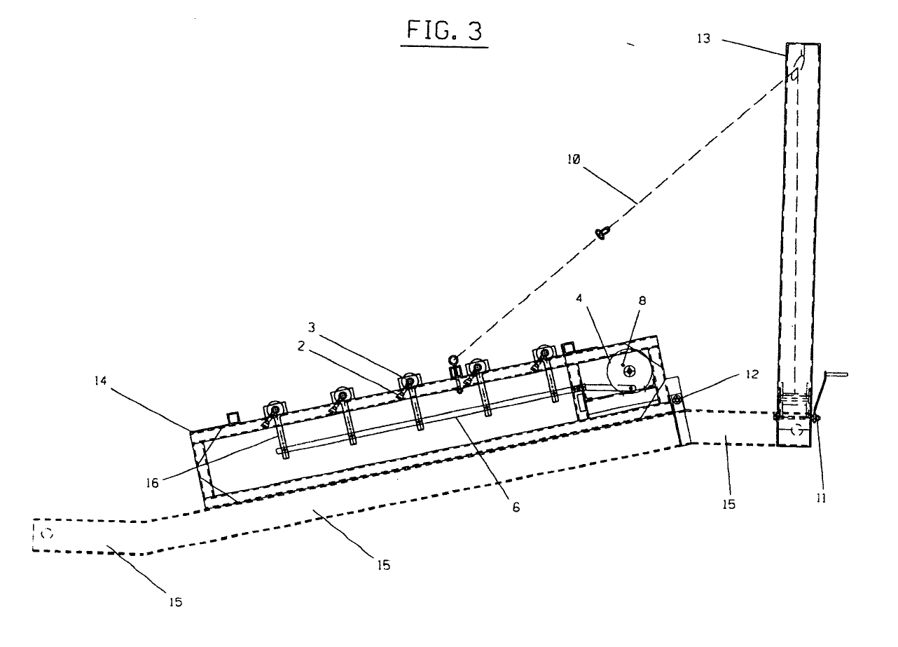

FIG. 3, which shows a right side view of the apparatus of FIG. 1, additionally shows a pivoting lever arm 16 which is fixedly connected to an end of the elongated spray bar 3. The lever arm 16 moves the elongated spray bar 3 in clockwise and counterclockwise directions. Also shown in FIG. 3 is an elongated connecting bar 6 which is hingedly connected at a point on lever arm 16 opposite to the end fixedly connected to the elongated spray bar. Movement of lever arm 16 is controlled by a motor 5 which, as shown in FIG. 1, may comprise a rotating disk 4 having a magnet 8 and two hall effect sensors 9. A linear actuator can also be used to control movement of the lever arm.

If a mechanism is used to control movement of the lever arm 16 (such as the motor/magnet/hall effect sensors shown in FIG. 1, a linear actuator or other type of mechanism), the mechanism will provide feedback to a control system of the position of the elongated spray bar, so that the flow of cleansing liquid may be turned on and off at particular points in the movement cycle of the spray bar.

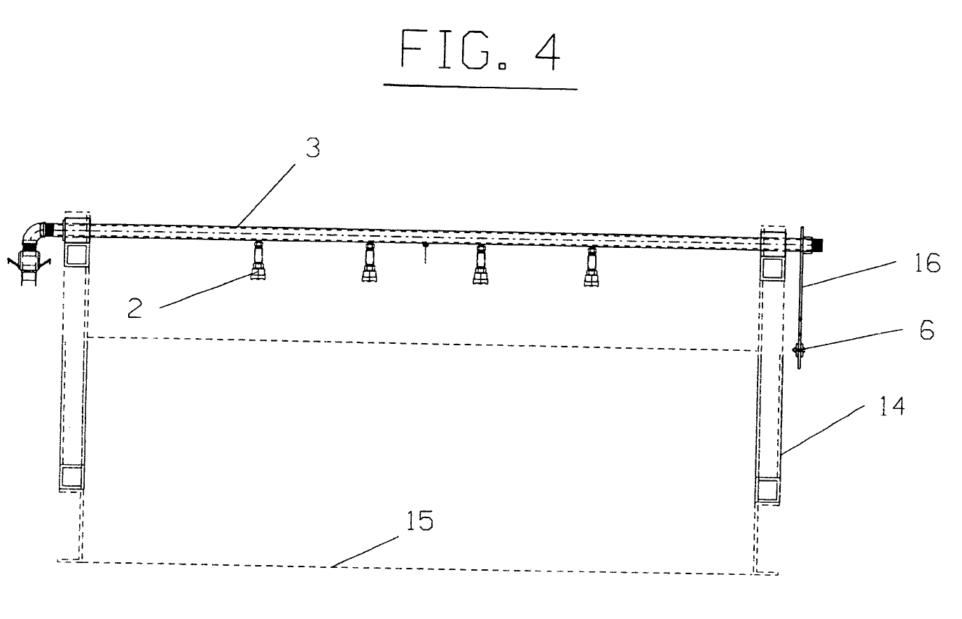

In FIG. 4, an elongated spray bar 3 is shown with nozzles 2, elongated connecting bar 6, lever arm 16 and screen 15.

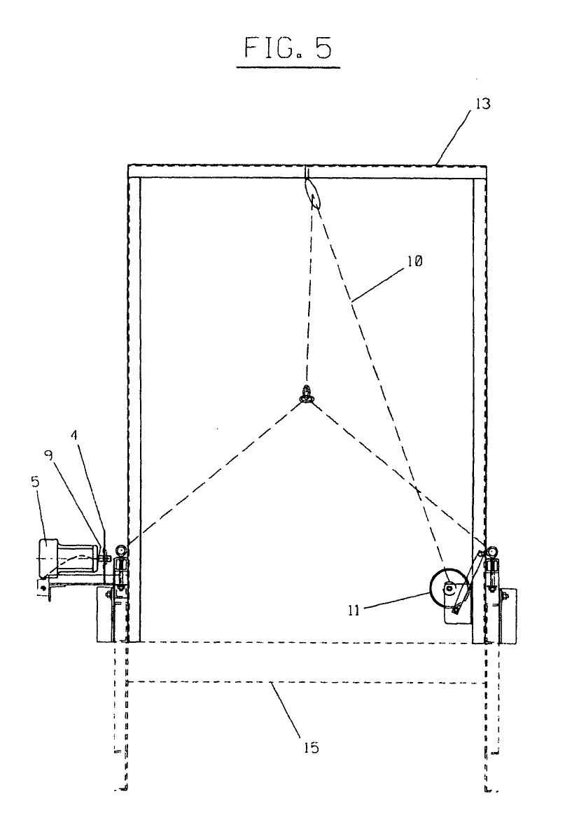

FIG. 5, a rear view of an apparatus according to this invention, shows screen 15 and an arrangement of cable 10, winch 11 and overhead bar assembly 13. Also shown in FIG. 5 is an electric motor 5, rotating disk 4 and hall effect sensor 9.

In this invention, either a single elongated spray bar can be used or, depending on the amount and type of material being screened, a plurality of spray bars can be used. When using a plurality, the spray bars can be rotated simultaneously, or each spray bar can be rotated at different intervals. In practice, the timing of the rotations can be controlled by various mechanisms, such as by an electric motor/magnets/hall effect sensor arrangement, a linear actuator, etc.

This invention also contemplates the use of a single elongated spray bar with either a plurality of nozzles or a single nozzle which is substantially the length of the screen used in the screening process.

In addition, the flow of cleansing liquid through the valve(s) can be intermittent in sequence with rotation of the elongated spray bar(s) or continuous. Depending on the material being screened, the cleansing liquid used in this invention may be water, which can also contain a dispersant, another liquid, an alcohol, etc.

The present invention is further illustrated by the following Examples 1-4, which illustrate certain embodiments designed to teach those of ordinary skill in this art how to practice this invention and to represent the best mode contemplated for practicing this invention.

To demonstrate how the screen washing apparatus of this invention improves the recovery of kaolin clay passing over screens where the apparatus of this invention is being used, tests were conducted on production scale screens that were equipped with flow measurement instrumentation. Kaolin recoveries were measured with the elongated spray bars on and then off. The measurements were taken after an hour of run time and after an hour of off time, which correlates to the fact that an operator could economically wash the screens once per hour.

In Examples 1-4, the term “gpm” refers to gallons per minute of the cleansing liquid, and the term “Tph” refers to tons per hour of the kaolin material being screened.

### Example 1

The first test was conducted on Derrick screens that were processing a fine kaolin clay process stream. The mesh size of the screen was 100 mesh. The recovery measurements were taken after an hour of run time with the wash bars on and after an hour with the wash bars off. The results of the first test and parameters are shown in Table 1.

TABLE 1

| Spray | Feed | | | Product | | | | |
|---|---|---|---|---|---|---|---|---|
| Bar | Rate | % | | Rate | % | | Recovery | % |
| Position | gpm | Solids | Tph | gpm | Solids | Tph | % | Improvement |
| On | 102 | 59.4 | 24.3 | 90 | 59.0 | 20.9 | 86.1 | 15.2 |
| Off | 120 | 59.7 | 28.4 | 90 | 59.6 | 21.3 | 74.8 | — |

### Example 2

The second test was also conducted on Derrick screens with a 100 mesh size for processing a fine kaolin clay process stream. The measurements were taken as described in Example 1. The test results and parameters are shown in Table 2.

TABLE 2

| Spray | Feed | | | Product | | | | |
|---|---|---|---|---|---|---|---|---|
| Bar | Rate | % | | Rate | % | | Recovery | % |
| Position | gpm | Solids | Tph | gpm | Solids | Tph | % | Improvement |
| On | 90 | 58.8 | 20.8 | 80 | 58.8 | 18.5 | 88.9 | 13.2% |
| Off | 90 | 59.3 | 21.5 | 72 | 59.3 | 16.9 | 78.5 | — |

### Example 3

The third test was again conducted on Derrick screens for processing a fine kaolin clay slurry. The screen size was 100 mesh. Measurements were taken as described in Example 1. The results parameters are shown in Table 3.

TABLE 3

| Spray | Feed | | | Product | | | | |
|---|---|---|---|---|---|---|---|---|
| Bar | Rate | % | | Rate | % | | Recovery | % |
| Position | gpm | Solids | Tph | gpm | Solids | Tph | % | Improvement |
| On | 60 | 59.6 | 14.2 | 41 | 59.4 | 9.6 | 68.0 | 14.1% |
| Off | 69.5 | 59.0 | 16.2 | 41.5 | 58.9 | 9.6 | 59.6 | — |

### Example 4

In the fourth test, the experiment was conducted on Derrick screens for processing a fine kaolin clay process stream. The screen size was 100 mesh, and measurements were taken as described in Example 1. The test results and parameters are shown in Table 4.

TABLE 4

| Spray | Feed | | | Product | | | | |
|---|---|---|---|---|---|---|---|---|
| Bar | Rate | % | | Rate | % | | Recovery | % |
| Position | gpm | Solids | Tph | gpm | Solids | Tph | % | Improvement |
| On | 98 | 59.6 | 23.2 | 72 | 59.3 | 16.9 | 72.9 | 10.8 |
| Off | 65 | 58.6 | 15.0 | 43 | 58.4 | 9.8 | 65.8 | |

In each of the above examples, when the apparatus of this invention was used the clay recovery increased by at least ten (10.0) percent. These results show that the apparatus of this invention is effectively keeping the screen openings clear of any near size material that may blind the screen and reduce efficiency of the screen. Over the course of a production cycle, use of the apparatus of this invention results in more product being recovered, decreased screen wear and lower production costs.

This invention has been described in detail with particular reference to certain embodiments, but variations and modifications can be made without departing from the spirit and scope of the invention.

What is claimed is:

1. An apparatus for removing residue from a screen in a screening process, wherein the apparatus comprises
A. a support frame for the apparatus;
B. an elongated spray bar being connected to a source of cleansing liquid; wherein at least one nozzle is fixedly connected to the elongated spray bar;
C. a pivoting lever arm for rotating the elongated spray bar in clockwise and counterclockwise directions and being fixedly connected to an end of the elongated spray bar;
D. an elongated connecting bar hingedly connected at a point on the lever arm opposite to the end fixedly connected to the elongated spray bar;
E. a mechanism for moving the lever arm in forward and rearward directions; and
F. a valve for controlling a flow of cleansing liquid to each nozzle.

2. An apparatus as defined by claim 1, wherein the cleansing liquid is water.

3. An apparatus as defined by claim 1, wherein each nozzle moves simultaneously with rotation of the elongated spray bar.

4. An apparatus as defined by claim 1, wherein rotation of the elongated spray bar is simultaneous with movement of the pivoting lever arm.

5. An apparatus as defined by claim 1, wherein the mechanism is an electric motor used with at least one magnet and at least one hall effect sensor.

6. An apparatus as defined by claim 1, wherein the mechanism is a linear actuator.

7. An apparatus as defined by claim 1, wherein the valve is a solenoid valve.

8. A process for removing residue from a screen in a screening process, wherein the process comprises the steps of:
A. placing a product to be screened onto a screen located under and at a distance from an elongated spray bar connected to a source of cleansing liquid;
wherein at least one nozzle is fixedly connected to the elongated spray bar, and
wherein the elongated spray bar is rotated in clockwise and counterclockwise directions by a pivoting lever arm which is fixedly connected to an end of the elongated spray bar and hingedly connected at a point on an elongated connecting bar;
B. providing a flow of cleansing liquid to and through each nozzle fixedly connected to the elongated spray bar and directed toward the screen,
wherein the cleansing liquid removes residue from the screen, and
wherein the flow of cleansing liquid and rotation of the elongated spray bar are controlled by an external device.

9. A process as defined by claim 8, wherein the cleansing liquid is water.

10. A process as defined by claim 8, wherein each nozzle moves simultaneously with rotation of the elongated spray bar.

11. A process as defined by claim 8, wherein rotation of the elongated spray bar is simultaneous with movement of the pivoting lever arm.

12. A process as denied by claim 8, wherein the mechanism is an electric motor used with at least one magnet and at lease one hall effect sensor.

13. A process as defined by claim 8, wherein the mechanism is a linear actuator.

14. A process as defined by claim 8, wherein the valve is a solenoid valve.
